(19) United States
(12) Patent Application Publication
(10) Pub. No.: US 2026/0236576 A1
(43) Pub. Date: Aug. 13, 2026

(54) Performance Determination of Machine Learning Models Based on Decision Boundary Geometry

(71) Applicant: VISA INTERNATIONAL SERVICE ASSOCIATION, San Francisco (CA)

(72) Inventors: Nicholas Stephen Kersting, Austin, TX (US); Joydeep Mitra, Austin, TX (US); Aman Mohanty, Austin, TX (US); Olawunmi George, Manor, TX (US); Sayali Sanjay Sakhalkar, Foster City, CA (US); Yi Li, Austin, TX (US)

(21) Appl. No.: 19/156,531

(22) PCT Filed: Feb. 15, 2024
(86) PCT No.: PCT/US2024/015949

§ 371 Date: Aug. 14, 2025

Related U.S. Application Data
(60) Provisional application No. 63/446,158, filed on Feb. 16, 2023.

(51) Int. Cl. G06F 21/55

(52) U.S. Cl. CPC G06F 21/554; G06F 2221/034

(57) ABSTRACT

Methods, systems, and computer program products are provided for determining performance of a machine learning model using decision boundary geometry. A method may include receiving data associated with a machine learning model, determining a decision boundary of the machine learning model, generating one or more metrics associated with a geometry of the decision boundary of the machine learning model, and determining whether to perform an action on the machine learning model based on the one or more metrics associated with the geometry of the decision boundary.

### CROSS REFERENCE TO RELATED APPLICATION

This application claims priority to U.S. Provisional Patent Application No. 63/446,158, filed on Feb. 16, 2023, the disclosure of which is incorporated by reference herein in its entirety.

### BACKGROUND

### 1. Technical Field

This disclosure relates generally to methods for measuring performance of machine learning models and, in some non-limiting embodiments or aspects, to methods, systems, and computer program products for determining performance of a machine learning model using decision boundary geometry.

### 2. Technical Considerations

Machine learning may refer to a field of computer science that uses statistical techniques to provide a computer system with the ability to learn (e.g., to progressively improve performance of) a task with data without the computer system being explicitly programmed to perform the task. In some instances, a machine learning model may be developed for a set of data so that the machine learning model may perform a task (e.g., a task associated with a prediction) with regard to the set of data.

In some instances, a machine learning model, such as a predictive machine learning model, may be used to make a prediction regarding a risk or an opportunity based on a large amount of data (e.g., a large scale dataset). A predictive machine learning model may be used to analyze a relationship between the performance of a unit based on a large scale dataset associated with the unit and one or more known features of the unit. The objective of the predictive machine learning model may be to assess the likelihood that a similar unit will exhibit the same or similar performance as the unit. In order to generate the predictive machine learning model, the large scale dataset may be segmented so that the predictive machine learning model may be trained on data that is appropriate.

However, a machine learning model deployed in a system may be in danger of low performance due to vulnerabilities that include situations where the machine learning model was trained on biased data, where live data distribution differs from training data distribution, and/or where targeted attacks on the machine learning model are made in a production environment. In some instances, the machine learning model may produce an output that is at odds with the original purpose of the machine learning model, such as detecting fraud. Attempts to redress such vulnerabilities may force reliance solely on detailed knowledge of the machine learning model and/or training environment. With this, attempts may include large amounts of time and resources (e.g., network and computational resources for training and/or validation processes) dedicated to determining whether the machine learning model is functioning as intended.

### SUMMARY

Accordingly, provided are improved methods, systems, and computer program products for determining performance of a machine learning model using decision boundary geometry.

According to non-limiting embodiments or aspects, provided is a computer-implemented method for performance determination of machine learning models based on decision boundary geometry. In some non-limiting embodiments or aspects, the computer-implemented method may include receiving data associated with a machine learning model. In some non-limiting embodiments or aspects, the computer-implemented method may further include determining classifications of the data associated with the machine learning model based on outputs of the machine learning model. In some non-limiting embodiments or aspects, the computer-implemented method may further include generating one or more metrics associated with a geometry of a decision boundary of the machine learning model. In some non-limiting embodiments or aspects, the computer-implemented method may further include determining whether to perform an action on the machine learning model based on the one or more metrics associated with the geometry of the decision boundary.

In some non-limiting embodiments or aspects, the computer-implemented method may further include comparing the one or more metrics associated with the geometry of the decision boundary to a threshold value. In some non-limiting embodiments or aspects, the computer-implemented method may further include determining whether the one or more metrics associated with the geometry of the decision boundary satisfy the threshold value. In some non-limiting embodiments or aspects, determining whether to perform the action on the machine learning model may include determining whether to perform the action on the machine learning model based on determining whether the one or more metrics associated with the geometry of the decision boundary satisfy the threshold value.

In some non-limiting embodiments or aspects, the one or more metrics may include at least one of the following: a metric associated with Voronoi cells; a metric associated with a cluster convexity; or any combination thereof.

In some non-limiting embodiments or aspects, generating the one or more metrics associated with the geometry of the decision boundary of the machine learning model may include generating the one or more metrics associated with the geometry of the decision boundary of the machine learning model at a predetermined time interval.

In some non-limiting embodiments or aspects, the one or more metrics associated with the geometry of the decision boundary of the machine learning model may be a metric associated with Voronoi cells. In some non-limiting embodiments or aspects, generating the one or more metrics associated with the geometry of the decision boundary may include receiving input data associated with the machine learning model. In some non-limiting embodiments or aspects, generating the one or more metrics associated with the geometry of the decision boundary may include computing a Voronoi diagram of the input data to provide a plurality of cells. In some non-limiting embodiments or aspects, generating the one or more metrics associated with the geometry of the decision boundary may include computing one or more interior points of each cell of the plurality of cells. In some non-limiting embodiments or aspects, generating the one or more metrics associated with the geometry of the decision boundary may include evaluating an output of the machine learning model based on the one or more interior points of each cell. In some non-limiting embodiments or aspects, generating the one or more metrics associated with the geometry of the decision boundary may include calculating the metric associated with the Voronoi cells based on the output of the machine learning model for the one or more interior points of each cell.

In some non-limiting embodiments or aspects, the one or more metrics associated with the geometry of the decision boundary of the machine learning model may be a metric associated with a cluster convexity. In some non-limiting embodiments or aspects, generating the one or more metrics associated with the geometry of the decision boundary may include receiving input data associated with the machine learning model. In some non-limiting embodiments or aspects, the input data may include a plurality of data points. In some non-limiting embodiments or aspects, generating the one or more metrics associated with the geometry of the decision boundary may include evaluating a first output of the machine learning model based on the plurality of data points. In some non-limiting embodiments or aspects, generating the one or more metrics associated with the geometry of the decision boundary may include partitioning the first output of the machine learning model into a plurality of clusters. In some non-limiting embodiments or aspects, generating the one or more metrics associated with the geometry of the decision boundary may include calculating a median data point for each pair of data points in each cluster of the plurality of clusters to provide a plurality of median data points. In some non-limiting embodiments or aspects, generating the one or more metrics associated with the geometry of the decision boundary may include evaluating a second output of the machine learning model based on the plurality of median data points. In some non-limiting embodiments or aspects, generating the one or more metrics associated with the geometry of the decision boundary may include calculating the metric associated with the cluster convexity based on the first output and the second output of the machine learning model.

In some non-limiting embodiments or aspect, the computer-implemented method may further include performing the action on the machine learning model based on determining that the one or more metrics associated with the geometry of the decision boundary satisfy a threshold value.

According to non-limiting embodiments or aspects, provided is a system for performance determination of machine learning models based on decision boundary geometry. In some non-limiting embodiments or aspects, the system may include at least one processor. In some non-limiting embodiments or aspects, the at least one processor may be configured to receive data associated with a machine learning model. In some non-limiting embodiments or aspects, the at least one processor may be further configured to determine classifications of the data associated with the machine learning model based on outputs of the machine learning model. In some non-limiting embodiments or aspects, the at least one processor may be configured to generate one or more metrics associated with a geometry of a decision boundary of the machine learning model. In some non-limiting embodiments or aspects, the at least one processor may be configured to determine whether to perform an action on the machine learning model based on the one or more metrics associated with the geometry of the decision boundary of the machine learning model.

In some non-limiting embodiments or aspects, the at least one processor may be configured to compare the one or more metrics associated with the geometry of the decision boundary to a threshold value. In some non-limiting embodiments or aspects, the at least one processor may be configured to determine whether the one or more metrics associated with the geometry of the decision boundary satisfy the threshold value. In some non-limiting embodiments or aspects, when determining whether to perform the action on the machine learning model, the at least one processor may be configured to determine whether to perform the action on the machine learning model based on determining whether the one or more metrics associated with the geometry of the decision boundary satisfy the threshold value.

In some non-limiting embodiments or aspects, the one or more metrics may include at least one of the following: a metric associated with Voronoi cells; a metric associated with a cluster convexity; or any combination thereof.

In some non-limiting embodiments or aspects, when generating the one or more metrics associated with the geometry of the decision boundary of the machine learning model, the at least one processor may be configured to generate the one or more metrics associated with the geometry of the decision boundary of the machine learning model at a predetermined time interval.

In some non-limiting embodiments or aspects, the one or more metrics associated with the geometry of the decision boundary of the machine learning model may be a metric associated with Voronoi cells. In some non-limiting embodiments or aspects, when generating the one or more metrics associated with the geometry of the decision boundary, the at least one processor may be configured to receive input data associated with the machine learning model. In some non-limiting embodiments or aspects, when generating the one or more metrics associated with the geometry of the decision boundary, the at least one processor may be configured to compute a Voronoi diagram of the input data to provide a plurality of cells. In some non-limiting embodiments or aspects, when generating the one or more metrics associated with the geometry of the decision boundary, the at least one processor may be configured to compute one or more interior points of each cell of the plurality of cells. In some non-limiting embodiments or aspects, when generating the one or more metrics associated with the geometry of the decision boundary, the at least one processor may be configured to evaluate an output of the machine learning model based on the one or more interior points of each cell. In some non-limiting embodiments or aspects, when generating the one or more metrics associated with the geometry of the decision boundary, the at least one processor may be configured to calculate the metric associated with the Voronoi cells based on the output of the machine learning model for the one or more interior points of each cell.

In some non-limiting embodiments or aspects, the one or more metrics associated with the geometry of the decision boundary of the machine learning model may be a metric associated with a cluster convexity. In some non-limiting embodiments or aspects, when generating the one or more metrics associated with the geometry of the decision boundary, the at least one processor may be configured to receive input data associated with the machine learning model. In some non-limiting embodiments or aspects, the input data may include a plurality of data points. In some non-limiting embodiments or aspects, when generating the one or more metrics associated with the geometry of the decision boundary, the at least one processor may be configured to evaluate a first output of the machine learning model based on the plurality of data points. In some non-limiting embodiments or aspects, when generating the one or more metrics associated with the geometry of the decision boundary, the at least one processor may be configured to partition the first output of the machine learning model into a plurality of clusters. In some non-limiting embodiments or aspects, when generating the one or more metrics associated with the geometry of the decision boundary, the at least one processor may be configured to calculate a median data point for each pair of data points in each cluster of the plurality of clusters to provide a plurality of median data points. In some non-limiting embodiments or aspects, when generating the one or more metrics associated with the geometry of the decision boundary, the at least one processor may be configured to evaluate a second output of the machine learning model based on the plurality of median data points. In some non-limiting embodiments or aspects, when generating the one or more metrics associated with the geometry of the decision boundary, the at least one processor may be configured to calculate the metric associated with the cluster convexity based on the first output and the second output of the machine learning model.

In some non-limiting embodiments or aspects, the at least one processor may be further configured to perform the action on the machine learning model based on determining that the one or more metrics associated with the geometry of the decision boundary satisfy a threshold value.

According to come non-limiting embodiments or aspects, provided is a computer program product for performance determination of machine learning models based on decision boundary geometry. In some non-limiting embodiments or aspects, the computer program product may include at least one non-transitory computer-readable medium including program instructions that, when executed by at least one processor, may cause the at least one processor to receive data associated with a machine learning model. In some non-limiting embodiments or aspects, the instructions may further cause the at least one processor to determine classifications of the data associated with the machine learning model based on outputs of the machine learning model. In some non-limiting embodiments or aspects, the instructions may further cause the at least one processor to generate one or more metrics associated with a geometry of a decision boundary of the machine learning model. In some non-limiting embodiments or aspects, the instructions may further cause the at least one processor to determine whether to perform an action on the machine learning model based on the one or more metrics associated with the geometry of the decision boundary.

In some non-limiting embodiments or aspects, the instructions may further cause the at least one processor to compare the one or more metrics associated with the geometry of the decision boundary to a threshold value. In some non-limiting embodiments or aspects, the instructions may further cause the at least one processor to determine whether the one or more metrics associated with the geometry of the decision boundary satisfy the threshold value. In some non-limiting embodiments or aspects, the instructions that cause the at least one processor to determine whether to perform the action on the machine learning model, may cause the at least one processor to determine whether to perform the action on the machine learning model based on determining whether the one or more metrics associated with the geometry of the decision boundary satisfy the threshold value.

In some non-limiting embodiments or aspects, the one or more metrics may include at least one of the following: a metric associated with Voronoi cells; a metric associated with a cluster convexity; or any combination thereof.

In some non-limiting embodiments or aspects, the instructions that cause the at least one processor to generate the one or more metrics associated with the geometry of the decision boundary of the machine learning model, may cause the at least one processor to generate the one or more metrics associated with the geometry of the decision boundary of the machine learning model at a predetermined time interval.

In some non-limiting embodiments or aspects, the one or more metrics associated with the geometry of the decision boundary of the machine learning model may be a metric associated with Voronoi cells. In some non-limiting embodiments or aspects, the instructions that cause the at least one processor to generate the one or more metrics associated with the geometry of the decision boundary, may cause the at least one processor to receive input data associated with the machine learning model. In some non-limiting embodiments or aspects, the instructions that cause the at least one processor to generate the one or more metrics associated with the geometry of the decision boundary, may cause the at least one processor to compute a Voronoi diagram of the input data to provide a plurality of cells. In some non-limiting embodiments or aspects, the instructions that cause the at least one processor to generate the one or more metrics associated with the geometry of the decision boundary, may cause the at least one processor to compute one or more interior points of each cell of the plurality of cells. In some non-limiting embodiments or aspects, the instructions that cause the at least one processor to generate the one or more metrics associated with the geometry of the decision boundary, may cause the at least one processor to evaluate an output of the machine learning model based on the one or more interior points of each cell. In some non-limiting embodiments or aspects, the instructions that cause the at least one processor to generate the one or more metrics associated with the geometry of the decision boundary, may cause the at least one processor to calculate the metric associated with the Voronoi cells based on the output of the machine learning model for the one or more interior points of each cell.

In some non-limiting embodiments or aspects, the one or more metrics associated with the geometry of the decision boundary of the machine learning model may be a metric associated with a cluster convexity. In some non-limiting embodiments or aspects, the instructions that cause the at least one processor to generate the one or more metrics associated with the geometry of the decision boundary, may cause the at least one processor to receive input data associated with the machine learning model. In some non-limiting embodiments or aspects, the input data may include a plurality of data points. In some non-limiting embodiments or aspects, the instructions that cause the at least one processor to generate the one or more metrics associated with the geometry of the decision boundary, may cause the at least one processor to evaluate a first output of the machine learning model based on the plurality of data points. In some non-limiting embodiments or aspects, the instructions that cause the at least one processor to generate the one or more metrics associated with the geometry of the decision boundary, may cause the at least one processor to partition the first output of the machine learning model into a plurality of clusters. In some non-limiting embodiments or aspects, the instructions that cause the at least one processor to generate the one or more metrics associated with the geometry of the decision boundary, may cause the at least one processor to calculate a median data point for each pair of data points in each cluster of the plurality of clusters to provide a plurality of median data points. In some non-limiting embodiments or aspects, the instructions that cause the at least one processor to generate the one or more metrics associated with the geometry of the decision boundary, may cause the at least one processor to evaluate a second output of the machine learning model based on the plurality of median data points. In some non-limiting embodiments or aspects, the instructions that cause the at least one processor to generate the one or more metrics associated with the geometry of the decision boundary, may cause the at least one processor to calculate the metric associated with the cluster convexity based on the first output and the second output of the machine learning model.

In some non-limiting embodiments or aspects, the instructions may further cause the at least one processor to perform the action on the machine learning model based on determining that the one or more metrics associated with the geometry of the decision boundary satisfy a threshold value.

Further non-limiting embodiments or aspects are set forth in the following numbered clauses:
Clause 1: A computer-implemented method for performance determination of machine learning models based on decision boundary geometry, the computer-implemented method comprising: receiving, with at least one processor, data associated with a machine learning model; determining, with at least one processor, classifications of the data associated with the machine learning model based on outputs of the machine learning model; generating, with at least one processor, one or more metrics associated with a geometry of a decision boundary of the machine learning model; and determining, with at least one processor, whether to perform an action on the machine learning model based on the one or more metrics associated with the geometry of the decision boundary.
Clause 2: The computer-implemented method of clause 1, further comprising: comparing the one or more metrics associated with the geometry of the decision boundary to a threshold value; and determining whether the one or more metrics associated with the geometry of the decision boundary satisfy the threshold value; wherein determining whether to perform the action on the machine learning model comprises: determining whether to perform the action on the machine learning model based on determining whether the one or more metrics associated with the geometry of the decision boundary satisfy the threshold value.
Clause 3: The computer-implemented method of clause 1 or 2, wherein the one or more metrics comprise at least one of the following: a metric associated with Voronoi cells; a metric associated with a cluster convexity; or any combination thereof.
Clause 4: The computer-implemented method of any of clauses 1-3, wherein generating the one or more metrics associated with the geometry of the decision boundary of the machine learning model comprises: generating the one or more metrics associated with the geometry of the decision boundary of the machine learning model at a predetermined time interval.
Clause 5: The computer-implemented method of any of clauses 1-4, wherein the one or more metrics associated with the geometry of the decision boundary of the machine learning model is a metric associated with Voronoi cells, and wherein generating the one or more metrics associated with the geometry of the decision boundary comprises: receiving input data associated with the machine learning model; computing a Voronoi diagram of the input data to provide a plurality of cells; computing one or more interior points of each cell of the plurality of cells; evaluating an output of the machine learning model based on the one or more interior points of each cell; and calculating the metric associated with the Voronoi cells based on the output of the machine learning model for the one or more interior points of each cell.
Clause 6: The computer-implemented method of any of clauses 1-5, wherein the one or more metrics associated with the geometry of the decision boundary of the machine learning model is a metric associated with a cluster convexity, and wherein generating the one or more metrics associated with the geometry of the decision boundary comprises: receiving input data associated with the machine learning model, wherein the input data comprises a plurality of data points; evaluating a first output of the machine learning model based on the plurality of data points; partitioning the first output of the machine learning model into a plurality of clusters; calculating a median data point for each pair of data points in each cluster of the plurality of clusters to provide a plurality of median data points; evaluating a second output of the machine learning model based on the plurality of median data points; and calculating the metric associated with the cluster convexity based on the first output and the second output of the machine learning model.
Clause 7: The computer-implemented method of any of clauses 1-6, further comprising: performing the action on the machine learning model based on determining that the one or more metrics associated with the geometry of the decision boundary satisfy a threshold value.
Clause 8: A system for performance determination of machine learning models based on decision boundary geometry, the system comprising: at least one processor configured to: receive data associated with a machine learning model; determine classifications of the data associated with the machine learning model based on outputs of the machine learning model; generate one or more metrics associated with a geometry of a decision boundary of the machine learning model; and determine whether to perform an action on the machine learning model based on the one or more metrics associated with the geometry of the decision boundary of the machine learning model.
Clause 9: The system of clause 8, wherein the at least one processor is further configured to: compare the one or more metrics associated with the geometry of the decision boundary to a threshold value; and determine whether the one or more metrics associated with the geometry of the decision boundary satisfy the threshold value; and wherein, when determining whether to perform the action on the machine learning model, the at least one processor is configured to: determine whether to perform the action on the machine learning model based on determining whether the one or more metrics associated with the geometry of the decision boundary satisfy the threshold value.
Clause 10: The system of clause 8 or 9, wherein the one or more metrics comprise at least one of the following: a metric associated with Voronoi cells; a metric associated with a cluster convexity; or any combination thereof.
Clause 11: The system of any of clauses 8-10, wherein, when generating the one or more metrics associated with the geometry of the decision boundary of the machine learning model, the at least one processor is configured to: generate the one or more metrics associated with the geometry of the decision boundary of the machine learning model at a predetermined time interval.
Clause 12: The system of any of clauses 8-11, wherein the one or more metrics associated with the geometry of the decision boundary of the machine learning model is a metric associated with Voronoi cells, and wherein, when generating the one or more metrics associated with the geometry of the decision boundary, the at least one processor is configured to: receive input data associated with the machine learning model; compute a Voronoi diagram of the input data to provide a plurality of cells; compute one or more interior points of each cell of the plurality of cells; evaluate an output of the machine learning model based on the one or more interior points of each cell; and calculate the metric associated with the Voronoi cells based on the output of the machine learning model for the one or more interior points of each cell.
Clause 13: The system of any of clauses 8-12, wherein the one or more metrics associated with the geometry of the decision boundary of the machine learning model is a metric associated with a cluster convexity, and wherein, when generating the one or more metrics associated with the geometry of the decision boundary, the at least one processor is configured to: receive input data associated with the machine learning model, wherein the input data comprises a plurality of data points; evaluate a first output of the machine learning model based on the plurality of data points; partition the first output of the machine learning model into a plurality of clusters; calculate a median data point for each pair of data points in each cluster of the plurality of clusters to provide a plurality of median data points; evaluate a second output of the machine learning model based on the plurality of median data points; and calculate the metric associated with the cluster convexity based on the first output and the second output of the machine learning model.
Clause 14: The system of any of clauses 8-13, wherein the at least one processor is further configured to: perform the action on the machine learning model based on determining that the one or more metrics associated with the geometry of the decision boundary satisfy a threshold value.
Clause 15: A computer program product for performance determination of machine learning models based on decision boundary geometry, the computer program product comprising at least one non-transitory computer-readable medium including program instructions that, when executed by at least one processor, cause the at least one processor to: receive data associated with a machine learning model; determine classifications of the data associated with the machine learning model based on outputs of the machine learning model; generate one or more metrics associated with a geometry of a decision boundary of the machine learning model; and determine whether to perform an action on the machine learning model based on the one or more metrics associated with the geometry of the decision boundary.
Clause 16: The computer program product of clause 15, wherein the instructions further cause the at least one processor to: compare the one or more metrics associated with the geometry of the decision boundary to a threshold value; and determine whether the one or more metrics associated with the geometry of the decision boundary satisfy the threshold value; and wherein, the instructions that cause the at least one processor to determine whether to perform the action on the machine learning model, cause the at least one processor to: determine whether to perform the action on the machine learning model based on determining whether the one or more metrics associated with the geometry of the decision boundary satisfy the threshold value.
Clause 17: The computer program product of clause 15 or 16, wherein the one or more metrics comprise at least one of the following: a metric associated with Voronoi cells; a metric associated with a cluster convexity; or any combination thereof.
Clause 18: The computer program product of any of clauses 15-17, wherein, the instructions that cause the at least one processor to generate the one or more metrics associated with the geometry of the decision boundary of the machine learning model, cause the at least one processor to: generate the one or more metrics associated with the geometry of the decision boundary of the machine learning model at a predetermined time interval.
Clause 19: The computer program product of any of clauses 15-18, wherein the one or more metrics associated with the geometry of the decision boundary of the machine learning model is a metric associated with Voronoi cells, and wherein, the instructions that cause the at least one processor to generate the one or more metrics associated with the geometry of the decision boundary, cause the at least one processor to: receive input data associated with the machine learning model; compute a Voronoi diagram of the input data to provide a plurality of cells; compute one or more interior points of each cell of the plurality of cells; evaluate an output of the machine learning model based on the one or more interior points of each cell; and calculate the metric associated with the Voronoi cells based on the output of the machine learning model for the one or more interior points of each cell.
Clause 20: The computer program product of any of clauses 15-19, wherein the one or more metrics associated with the geometry of the decision boundary of the machine learning model is a metric associated with a cluster convexity, and wherein, the instructions that cause the at least one processor to generate the one or more metrics associated with the geometry of the decision boundary, cause the at least one processor to: receive input data associated with the machine learning model, wherein the input data comprises a plurality of data points; evaluate a first output of the machine learning model based on the plurality of data points; partition the first output of the machine learning model into a plurality of clusters; calculate a median data point for each pair of data points in each cluster of the plurality of clusters to provide a plurality of median data points; evaluate a second output of the machine learning model based on the plurality of median data points; and calculate the metric associated with the cluster convexity based on the first output and the second output of the machine learning model.
Clause 21: The computer program product of any of clauses 15-20, wherein the instructions further cause the at least one processor to: perform the action on the machine learning model based on determining that the one or more metrics associated with the geometry of the decision boundary satisfy a threshold value.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is a schematic diagram of a system for determining performance of a machine learning model using decision boundary geometry, according to some non-limiting embodiments or aspects;

FIG. 2 is a flow diagram of a method for determining performance of a machine learning model using decision boundary geometry, according to some non-limiting embodiments or aspects;

FIGS. 3A-3D are flow diagrams of methods for generating one or more metrics associated with a geometry of a decision boundary of a machine learning model, according to some non-limiting embodiments or aspects;

FIGS. 4A-4E are schematic diagrams of an exemplary implementation of a system and/or method for authentication of an identity of a user, according to some non-limiting embodiments or aspects;

FIG. 5 is a diagram of an exemplary environment in which systems, methods, and/or computer program products, described herein, may be implemented, according to some non-limiting embodiments or aspects; and

FIG. 6 is a schematic diagram of example components of one or more devices of FIG. 1 and/or FIG. 5, according to some non-limiting embodiments or aspects.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects of the disclosed subject matter. Hence, specific dimensions and other physical characteristics related to the embodiments or aspects disclosed herein are not to be considered as limiting.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

As used herein, the term “acquirer” may refer to an entity licensed by the transaction service provider and approved by the transaction service provider to originate transactions (e.g., payment transactions) involving a payment device associated with the transaction service provider. As used herein, the term “acquirer system” may also refer to one or more computer systems, computer devices, and/or the like operated by or on behalf of an acquirer. The transactions the acquirer may originate may include payment transactions (e.g., purchases, original credit transactions (OCTs), account funding transactions (AFTs), and/or the like). In some non-limiting embodiments, the acquirer may be authorized by the transaction service provider to assign merchant or service providers to originate transactions involving a payment device associated with the transaction service provider. The acquirer may contract with payment facilitators to enable the payment facilitators to sponsor merchants. The acquirer may monitor the compliance of the payment facilitators in accordance with regulations of the transaction service provider. The acquirer may conduct due diligence of the payment facilitators and ensure proper due diligence occurs before signing a sponsored merchant. The acquirer may be liable for all transaction service provider programs that the acquirer operates or sponsors. The acquirer may be responsible for the acts of the acquirer's payment facilitators, merchants that are sponsored by the acquirer's payment facilitators, and/or the like. In some non-limiting embodiments, an acquirer may be a financial institution, such as a bank.

As used herein, the terms “issuer,” “issuer institution,” “issuer bank,” or “payment device issuer,” may refer to one or more entities that provide accounts to individuals (e.g., users, customers, and/or the like) for conducting payment transactions, such as credit payment transactions and/or debit payment transactions. For example, an issuer institution may provide an account identifier, such as a primary account number (PAN), to a customer that uniquely identifies one or more accounts associated with that customer. In some non-limiting embodiments, an issuer may be associated with a bank identification number (BIN) that uniquely identifies the issuer institution. As used herein, the term “issuer system” may refer to one or more computer systems operated by or on behalf of an issuer, such as a server executing one or more software applications. For example, an issuer system may include one or more authorization servers for authorizing a transaction.

As used herein, the term “merchant” may refer to one or more entities (e.g., operators of retail businesses) that provide goods and/or services, and/or access to goods and/or services, to a user (e.g., a customer, a consumer, and/or the like) based on a transaction, such as a payment transaction. As used herein, the term “merchant system” may refer to one or more computer systems operated by or on behalf of a merchant, such as a server executing one or more software applications. As used herein, the term “product” may refer to one or more goods and/or services offered by a merchant.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa®, MasterCard®, American Express®, or any other entity that processes transactions. As used herein, the term “transaction service provider system” may refer to one or more computer systems operated by or on behalf of a transaction service provider, such as a transaction service provider system executing one or more software applications. A transaction service provider system may include one or more processors and, in some non-limiting embodiments or aspects, may be operated by or on behalf of a transaction service provider.

Non-limiting embodiments or aspects of the present disclosure are directed to methods, systems, and computer program products for determining performance of a machine learning model using decision boundary geometry. In some non-limiting embodiments or aspects, a geometric analysis system may be configured to receive data associated with a machine learning model, determine a decision boundary of the machine learning model, generate one or more metrics associated with a geometry of the decision boundary of the machine learning model, and determine whether to perform an action on the machine learning model based on the one or more metrics associated with the geometry of the decision boundary. In some non-limiting embodiments or aspects, the geometric analysis system may compare the one or more metrics associated with the geometry of the decision boundary to a threshold value, determine whether the one or more metrics associated with the geometry of the decision boundary satisfy the threshold value, and, when determining whether to perform the action on the machine learning model, the geometric analysis system may determine whether to perform the action on the machine learning model based on determining whether the one or more metrics associated with the geometry of the decision boundary satisfy the threshold value.

In some non-limiting embodiments or aspects, the one or more metrics may include a metric associated with pairs of data points. In some non-limiting embodiments or aspects, the one or more metrics may include a metric associated with Voronoi cells and/or a metric associated with cluster convexity. In some non-limiting embodiments or aspects, when generating the one or more metrics associated with the geometry of the decision boundary of the machine learning model, the geometric analysis system may generate the one or more metrics associated with the geometry of the decision boundary of the machine learning model at a predetermined time interval. In some non-limiting embodiments or aspects, the one or more metrics associated with the geometry of the decision boundary of the machine learning model is a metric associated with Voronoi cells, and, when generating the one or more metrics associated with the geometry of the decision boundary, the geometric analysis system may receive input data associated with the machine learning model, compute a Voronoi diagram of the input data to provide a plurality of cells, compute one or more interior points of each cell of the plurality of cells, evaluate an output of the machine learning model based on the one or more interior points of each cell, and calculate the metric associated with Voronoi cells based on the output of the machine learning model for the one or more interior points of each cell.

In some non-limiting embodiments or aspects, the one or more metrics associated with the geometry of the decision boundary of the machine learning model is a metric associated with Voronoi cells, and, when generating the one or more metrics associated with the geometry of the decision boundary, the geometric analysis system may receive input data associated with the machine learning model, wherein the input data comprises a plurality of data points, evaluate a first output of the machine learning model based on the plurality of data points, partition the first output of the machine learning model into a plurality of clusters, calculate a median data point for each pair of data points in each cluster of the plurality of clusters to provide a plurality of median data points, evaluate a second output of the machine learning model based on the plurality of median data points, and calculate a metric associated with cluster convexity based on the first output and the second output of the machine learning model. In some non-limiting embodiments or aspects, the geometric analysis system may perform the action on the machine learning model based on determining that the one or more metrics associated with the geometry of the decision boundary satisfy a threshold value.

In this way, the geometric analysis system may allow for accurately determining whether a machine learning model is providing an accurate result with a reduced amount of resources (e.g., network and/or computational resources). The geometric analysis system may prevent the need for training and/or validating (e.g., retraining and/or revalidating) the machine learning model. Furthermore, the geometric analysis system may reduce the number of vulnerabilities that lead to low performance of a machine learning model that is deployed in a system that performs operations using the machine learning model.

In some non-limiting embodiments or aspects, the geometric analysis system may leverage the understanding that non-sensical model outputs (e.g. incorrectly labelled data input) may be due to a geometric flaw in a mathematical shape of a decision boundary of the machine learning model. In some non-limiting embodiments or aspects, the geometric analysis system may operate at any location in a production pipeline of the machine learning. In some non-limiting embodiments or aspects, the geometric analysis system may measure geometric properties of the decision boundary of the machine learning model and/or provide a report of an issue (e.g., provide a report to a system for a model developer to redress). Furthermore, an advantage of the geometric analysis system may be that operations carried out by the geometric analysis system are model-agnostic as geometric techniques are used to measure the decision space, which do not require a specific type or configuration of the machine learning model.

For the purpose of illustration, in the following description, while the presently disclosed subject matter is described with respect to methods, systems, and computer program products for determining performance of a machine learning model using decision boundary geometry, one skilled in the art will recognize that the disclosed subject matter is not limited to the non-limiting embodiments or aspects disclosed herein. For example, the methods, systems, and computer program products described herein may be used with a wide variety of settings, such as generating machine learning models, determining machine learning model performance, and/or determining whether to modify (e.g., train, re-train, re-validate, etc.) a machine learning model based on performance in any suitable setting, such as an offline setting and/or a production setting for any suitable purpose, such as predictions, regressions, classifications, fraud prevention, authorization, authentication, identification, feature selection, recommendations, and/or the like.

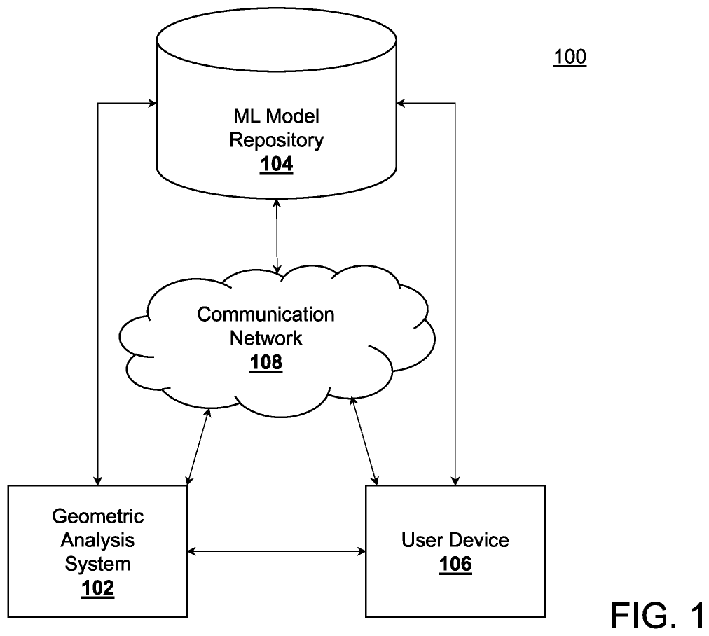

Referring now to FIG. 1, FIG. 1 is a schematic diagram of system 100 for determining performance of a machine learning model using decision boundary geometry, according to some non-limiting embodiments or aspects. As shown in FIG. 1, system 100 may include geometric analysis system 102, machine learning (ML) model repository 104, user device 106, and communication network 108. Geometric analysis system 102, ML model repository 104, and/or user device 106 may interconnect (e.g., establish a connection to communicate) via wired connections, wireless connections, or a combination of wired and wireless connections.

Geometric analysis system 102 may include one or more devices configured to communicate with ML model repository 104 and/or user device 106 via communication network 108. For example, geometric analysis system 102 may include a computing device, such as a server (e.g., a single server), a group of servers, and/or other like devices. In some non-limiting embodiments or aspects, geometric analysis system 102 may include a processor and/or memory, as described herein. In some non-limiting embodiments or aspects, geometric analysis system 102 may include one or more software instructions (e.g., one or more software applications) executing on a server (e.g., a single server), a group of servers, a computing device (e.g., a single computing device), a group of computing devices, and/or other like devices. In some non-limiting embodiments or aspects, geometric analysis system 102 may be configured to perform one or more steps of methods described herein. In some non-limiting embodiments or aspects, geometric analysis system 102 may be configured to communicate with a data storage device (e.g., ML model repository 104). In some non-limiting embodiments or aspects, geometric analysis system 102 may be in communication with ML model repository 104 and/or user device 106, such that geometric analysis system 102 is separate from ML model repository 104 and/or user device 106. In some non-limiting embodiments or aspects, user device 106 and/or ML model repository 104 may be implemented by (e.g., may be part of) geometric analysis system 102.

In some non-limiting embodiments or aspects, geometric analysis system 102 may generate (e.g., train, validate, re-train, and/or the like), store, and/or implement (e.g., operate, provide inputs to and/or outputs from, and/or the like) one or more machine learning models. For example, geometric analysis system 102 may generate one or more machine learning models by fitting (e.g., validating, testing, etc.) one or more machine learning models against data used for training (e.g., training data). In some non-limiting embodiments or aspects, geometric analysis system 102 may generate, store, and/or implement one or more machine learning models that are provided for a production environment (e.g., a runtime environment, a real-time environment, etc.) used for providing inferences (e.g., secure inferences) based on data inputs in a live situation (e.g., real-time situation). Additionally or alternatively, geometric analysis system 102 may generate, store, and/or implement one or more machine learning models that are provided for a non-production environment (e.g., an offline environment, a training environment, etc.) used for providing inferences based on data inputs in a situation that is not live. In some non-limiting embodiments or aspects, geometric analysis system 102 may be in communication with a data storage device (ML model repository 104), which may be local or remote to geometric analysis system 102.

ML model repository 104 may include one or more devices that are capable of being in communication with geometric analysis system 102 and/or user device 106 via communication network 108. For example, ML model repository 104 may include a computing device, such as a server (e.g., a single server), a group of servers, and/or other like devices. In some non-limiting embodiments or aspects, ML model repository 104 may receive, store, and/or provide (e.g., transmit) one or more machine learning models. In some non-limiting embodiments or aspects, ML model repository 104 may be associated with one or more computing devices providing interfaces, such that a user (e.g., an administrative user, a user using a service account, and/or the like) may interact with ML model repository 104 via the one or more computing devices. ML model repository 104 may be in communication with geometric analysis system 102 and/or user device 106, such that ML model repository 104 is separate from geometric analysis system 102 and/or user device 106. Alternatively, in some non-limiting embodiments or aspects, ML model repository 104 may be implemented by (e.g., may be part of) geometric analysis system 102 and/or user device 106.

User device 106 may include a computing device configured to communicate with geometric analysis system 102 and/or ML model repository 104 via communication network 108. For example, user device 106 may include a computing device, such as a desktop computer, a portable computer (e.g., tablet computer, a laptop computer, and/or the like), a mobile device (e.g., a cellular phone, a smartphone, a personal digital assistant, a wearable device, and/or the like), and/or other like devices. In some non-limiting embodiments or aspects, user device 106 may be associated with a user (e.g., an individual operating user device 106).

Communication network 108 may include one or more wired and/or wireless networks. For example, communication network 108 may include a cellular network (e.g., a long-term evolution (LTE) network, a third-generation (3G) network, a fourth-generation (4G) network, a fifth-generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN) and/or the like), a private network, an ad hoc network, an intranet, the Internet, a fiber optic-based network, a cloud computing network, and/or the like, and/or a combination of some or all of these or other types of networks.

The number and arrangement of devices and networks shown in FIG. 1 are provided as an example. There may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally or alternatively, a set of devices (e.g., one or more devices) of system 100 may perform one or more functions described as being performed by another set of devices of system 100.

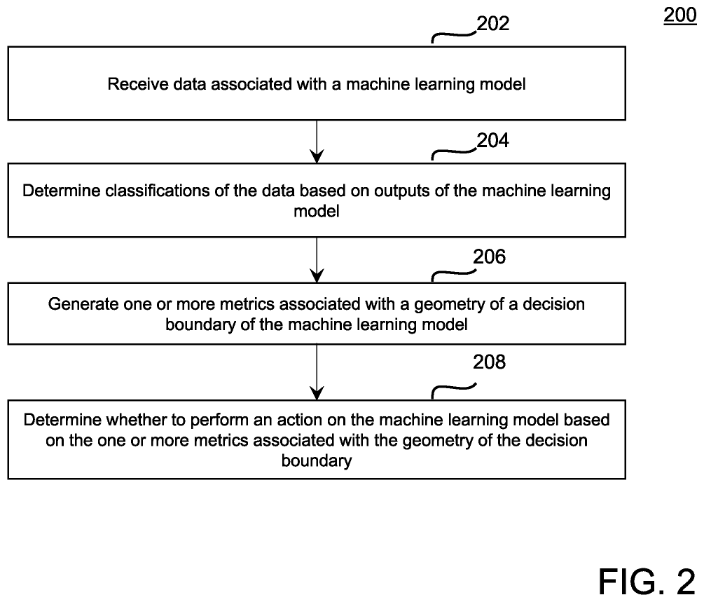

Referring now to FIG. 2, FIG. 2 is a flow diagram of a non-limiting embodiment or aspect of process 200 for determining performance of a machine learning model using decision boundary geometry. In some non-limiting embodiments or aspects, one or more of the steps of process 200 may be performed (e.g., completely, partially, etc.) by geometric analysis system 102 (e.g., one or more devices of geometric analysis system 102). In some non-limiting embodiments or aspects, one or more of the steps of process 200 may be performed (e.g., completely, partially, etc.) by another device or a group of devices separate from or including geometric analysis system 102 (e.g., one or more devices of geometric analysis system 102), ML model repository 104 (e.g., one or more devices of ML model repository 104), and/or user device 106.

As shown in FIG. 2, at step 202, process 200 includes receiving data associated with a machine learning model. For example, geometric analysis system 102 may receive data associated with a machine learning model. In some non-limiting embodiments or aspects, the machine learning model may include a classification machine learning model that is configured to receive an input and to provide an output based on the input, wherein the output includes a prediction (e.g., a prediction score) of a classification (e.g., a label for a classification). In some non-limiting embodiments or aspects, the data associated with the machine learning model may include a dataset (e.g., an initial dataset) that includes a plurality of data points (e.g., data instances, data examples, etc.). In some non-limiting embodiments or aspects, the dataset may include initial data associated with the machine learning model, where the initial data comprises a plurality of initial data points to be provided as inputs to the machine learning model.

In some non-limiting embodiments or aspects, geometric analysis system 102 may receive the dataset from ML model repository 104, user device 106, and/or another device or system. In some non-limiting embodiments or aspects, the data associated with the machine learning model may include one or more files (e.g., executable files) for executing the machine learning model.

In some non-limiting embodiments or aspects, the dataset may be associated with a population of entities (e.g., users, accountholders, merchants, issuers, etc.). For example, the plurality of initial data points may represent a plurality of transactions (e.g., electronic payment transactions) conducted by the population. In some examples, the plurality of initial data points may include a large amount of data points, such as 100 data points, 500 data points, 1,000 data points, 5,000 data points, 10,000 data points, 25,000 data points, 50,000 data points, 100,000 data points, 1,000,000 data points, and/or the like. In some examples, the plurality of initial data points may be associated with a plurality of features.

In some non-limiting embodiments or aspects, each data point may include transaction data associated with a transaction (e.g., an electronic payment transaction). In some non-limiting embodiments or aspects, the transaction data may include a plurality of transaction parameters associated with an electronic payment transaction. In some non-limiting embodiments or aspects, the plurality of features may represent the plurality of transaction parameters. In some non-limiting embodiments or aspects, the plurality of transaction parameters may include electronic wallet card data associated with an electronic card (e.g., an electronic credit card, an electronic debit card, an electronic loyalty card, and/or the like), decision data associated with a decision (e.g., a decision to approve or deny a transaction authorization request), authorization data associated with an authorization response (e.g., an approved spending limit, an approved transaction value, and/or the like), a primary account number (PAN), an authorization code (e.g., a personal identification number (PIN), etc.), data associated with a transaction amount (e.g., an approved limit, a transaction value, etc.), data associated with a transaction date and time, data associated with a conversion rate of a currency, data associated with a merchant type (e.g., a merchant category code that indicates a type of goods, such as grocery, fuel, and/or the like), data associated with an acquiring institution country, data associated with an identifier of a country associated with the PAN, data associated with a response code, data associated with a merchant identifier (e.g., a merchant name, a merchant location, and/or the like), data associated with a type of currency corresponding to funds stored in association with the PAN, and/or the like.

As shown in FIG. 2, at step 204, process 200 includes determining classifications of the data based on outputs of machine learning model. For example, geometric analysis system 102 may determine classifications of the data associated with the machine learning model based on outputs of the machine learning model.

In some non-limiting embodiments or aspects, geometric analysis system 102 may provide the plurality of initial data points as inputs to the machine learning model to provide a plurality of initial outputs. For example, geometric analysis system 102 may provide one or more data points (e.g., all data points, some data points, a subset of all data points, etc.) of the plurality of initial data points as inputs to the machine learning model to provide one or more initial outputs based on the inputs. Each output of the plurality of initial outputs may have a classification. For example, each output of the plurality of initial outputs may have a label (e.g., a score for a label) associated with a prediction of a classification (e.g., a predicted classification) of the output.

In some non-limiting embodiments or aspects, geometric analysis system 102 may generate a test dataset based on an initial dataset. The test dataset may include a plurality of test data points that correspond to one or more data points of the initial dataset. In one example, geometric analysis system 102 may generate the test dataset based on the plurality of data points of the initial dataset. In some non-limiting embodiments or aspects, geometric analysis system 102 may generate the plurality of test data points of the test dataset by interpolating the plurality of test data points based on (e.g., from) the plurality of initial data points of the initial dataset.

In some non-limiting embodiments or aspects, geometric analysis system 102 may provide the plurality of test data points as inputs to the machine learning model to provide a plurality of test outputs. For example, geometric analysis system 102 may provide one or more data points (e.g., all data points, some data points, a subset of all data points, etc.) of the plurality of test data points as inputs to the machine learning model to provide one or more test outputs based on the inputs. Each output of the plurality of test outputs may have a classification. For example, each output of the plurality of test outputs may have a label (e.g., a score for a label) associated with a prediction of a classification (e.g., a predicted classification) of the output.

As shown in FIG. 2, at step 206, process 200 includes generating one or more metrics associated with a geometry of a decision boundary of the machine learning model. For example, geometric analysis system 102 may generate one or more metrics associated with the geometry of the decision boundary of the machine learning model. In some non-limiting embodiments or aspects, geometric analysis system 102 may generate the one or more metrics associated with the geometry of the decision boundary of the machine learning model by comparing the plurality of initial outputs of the machine learning model and the plurality of test outputs of the machine learning model. In some non-limiting embodiments or aspects, the one or more metrics associated with a geometry of the decision boundary of the machine learning model may be based on a number of the plurality of initial outputs of the machine learning model that have a classification that corresponds (e.g., matches) to a classification of the plurality of test outputs of the machine learning model.

In some non-limiting embodiments or aspects, the one or more metrics may include a metric associated with Voronoi cells, a metric associated with cluster convexity, a metric associated with harmonicity, and/or a metric associated with fractal dimensions. In some non-limiting embodiments or aspects, the one or more metrics associated with a geometry of the decision boundary of the machine learning model may represent a measure of precision and/or a measure of robustness of the machine learning model.

In some non-limiting embodiments or aspects, geometric analysis system 102 may generate the one or more metrics associated with the geometry of the decision boundary of the machine learning model at a predetermined time interval. For example, geometric analysis system 102 may generate the one or more metrics associated with the geometry of the decision boundary of the machine learning model according to a daily time interval, a weekly time interval, a monthly time interval, a bi-monthly time interval, a quarter annual time interval, a bi-annual time interval, an annual time interval, and/or the like.

In some non-limiting embodiments or aspects, the predetermined time interval may be based on whether the machine learning model is a production machine learning model or a non-production machine learning model. For example, the predetermined time interval may be a shorter time interval if the machine learning model is a production machine learning model than if the machine learning model is a non-production machine learning model.

In some non-limiting embodiments or aspects, geometric analysis system 102 may compare the one or more metrics associated with the geometry of the decision boundary to a threshold value and determine whether the one or more metrics associated with the geometry of the decision boundary satisfy the threshold value.

In some non-limiting embodiments or aspects, geometric analysis system 102 may determine a decision boundary of the machine learning model. In some non-limiting embodiments or aspects, geometric analysis system 102 may determine the decision boundary of the machine learning model based on a plurality of outputs of the machine learning model that are provided based on a plurality of inputs to the machine learning model. In one example, geometric analysis system 102 may determine the decision boundary of the machine learning model based on each label associated with a prediction of a classification of each output of the plurality of outputs.

In some non-limiting embodiments or aspects, geometric analysis system 102 may determine a decision boundary of the machine learning model based on the plurality of outputs of the machine learning model. For example, geometric analysis system 102 may determine the decision boundary as a surface in feature space where predictions of the machine learning model change from one classification to another. In another example, geometric analysis system 102 may determine the decision boundary as a surface in feature space where scores associated with predictions of the machine learning model change from one threshold value to another.

As shown in FIG. 2, at step 208, process 200 includes determining whether to perform an action on the machine learning model based on the one or more metrics associated with the geometry of the decision boundary. For example, geometric analysis system 102 may determine whether to perform an action on the machine learning model based on the one or more metrics associated with the geometry of the decision boundary.

In some non-limiting embodiments or aspects, geometric analysis system 102 may determine whether to perform the action on the machine learning model based on determining whether the one or more metrics associated with the geometry of the decision boundary satisfy a threshold value (e.g., a threshold value associated with the metric of the geometry of the decision boundary). For example, geometric analysis system 102 may determine to perform the action on the machine learning model based on determining that the one or more metrics associated with the geometry of the decision boundary satisfies the threshold value. In such an example, geometric analysis system 102 may determine to forego performing the action on the machine learning model based on determining that the one or more metrics associated with the geometry of the decision boundary does not satisfy the threshold value.

In some non-limiting embodiments or aspects, geometric analysis system 102 may perform an action, such as a fraud prevention procedure, a creditworthiness procedure, and/or a recommendation procedure, using a machine learning model (e.g., a trained machine learning model in a production environment). For example, geometric analysis system 102 may perform the action based on determining to perform the action. In some non-limiting embodiments or aspects, geometric analysis system 102 may perform a fraud prevention procedure associated with protection of an account of a user (e.g., a user associated with user device 106) based on an output of the machine learning model (e.g., an output that includes a prediction associated with the account of the user). For example, if the output of the machine learning model indicates that the fraud prevention procedure is necessary, geometric analysis system 102 may perform the fraud prevention procedure associated with protection of the account of the user. In such an example, if the output of the machine learning model indicates that the fraud prevention procedure is not necessary, geometric analysis system 102 may forego performing the fraud prevention procedure associated with protection of the account of the user. In some non-limiting embodiments or aspects, geometric analysis system 102 may execute a fraud prevention procedure based on a classification of an input as provided by the machine learning model.

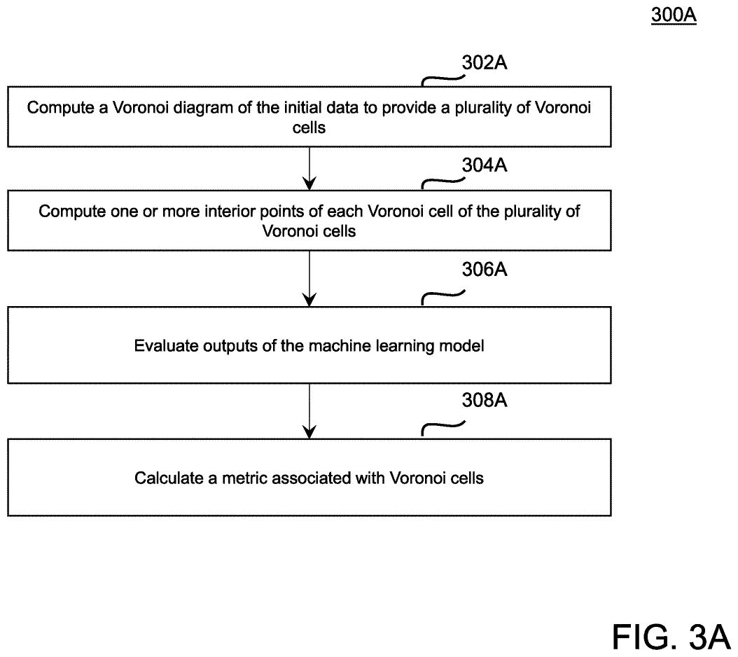

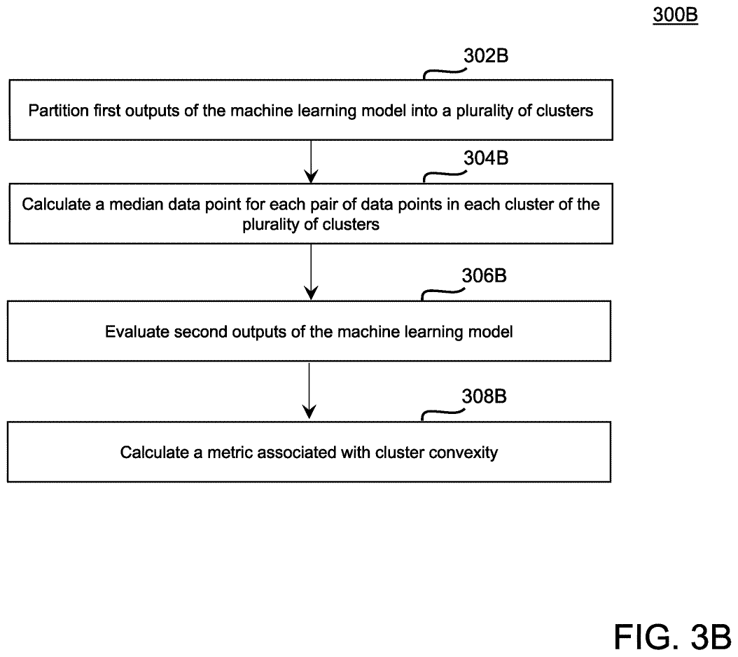

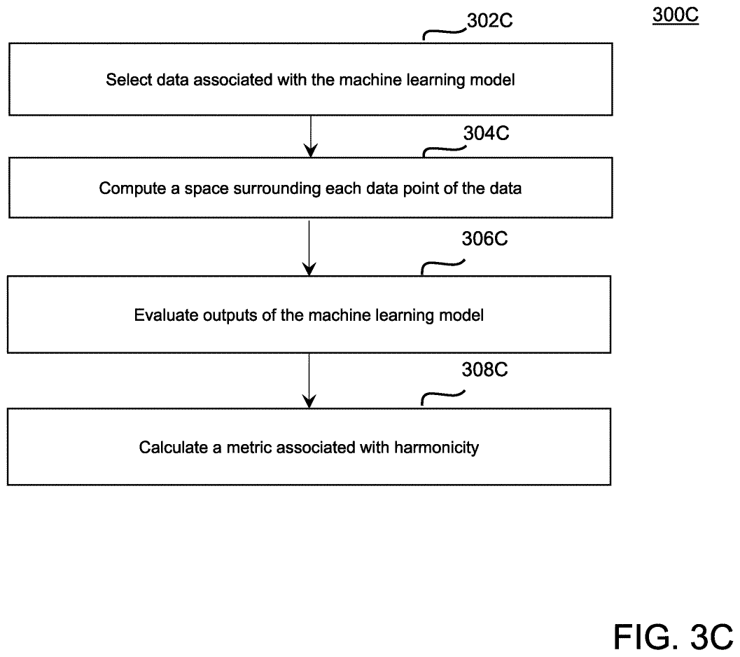

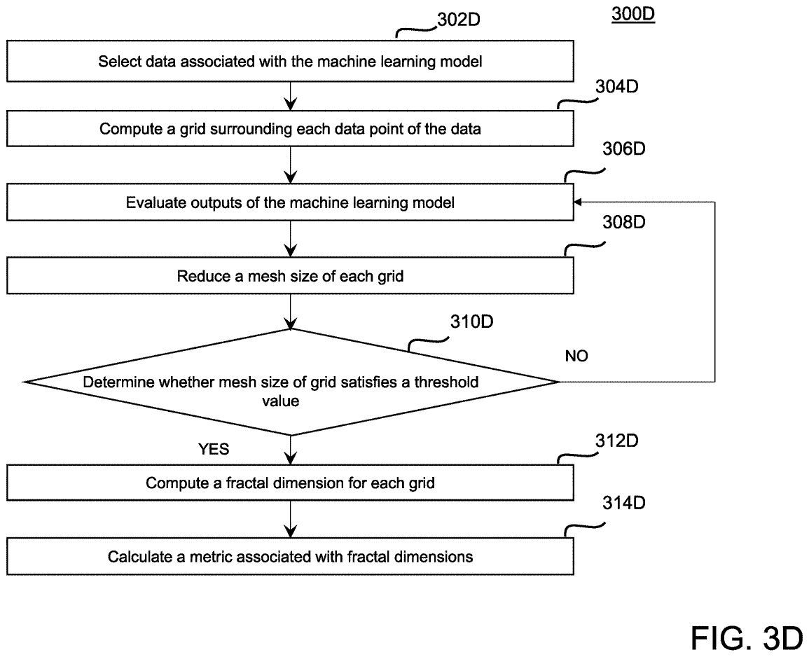

Referring now to FIGS. 3A-3D, FIGS. 3A-3D are flow diagrams of non-limiting embodiments or aspects of processes 300A-300D for generating one or more metrics associated with a geometry of a decision boundary of the machine learning model (e.g., step 206 of process 200). In some non-limiting embodiments or aspects, one or more of the steps of each of processes 300A-300D may be performed (e.g., completely, partially, etc.) by geometric analysis system 102 (e.g., one or more devices of geometric analysis system 102). In some non-limiting embodiments or aspects, one or more of the steps of process 300 may be performed (e.g., completely, partially, etc.) by another device or a group of devices separate from or including geometric analysis system 102 (e.g., one or more devices of geometric analysis system 102), ML model repository 104 (e.g., one or more devices of ML model repository 104), and/or user device 106.

Referring now to FIG. 3A, FIG. 3A is a flow diagram of a non-limiting embodiment or aspect of process 300A for generating a metric associated with Voronoi cells with regard to a machine learning model. In some non-limiting embodiments or aspects, one or more of the steps of process 300A may be performed (e.g., completely, partially, etc.) by geometric analysis system 102 (e.g., one or more devices of geometric analysis system 102). In some non-limiting embodiments or aspects, one or more of the steps of process 300A may be performed (e.g., completely, partially, etc.) by another device or a group of devices separate from or including geometric analysis system 102 (e.g., one or more devices of geometric analysis system 102), ML model repository 104 (e.g., one or more devices of ML model repository 104), and/or user device 106.

As shown in FIG. 3A, at step 302A, process 300A includes computing a Voronoi diagram of the initial data to provide a plurality of Voronoi cells. For example, geometric analysis system 102 may compute a Voronoi diagram of the initial dataset of the plurality of initial data points to provide a plurality of Voronoi cells (e.g., Voronoi Tessellations). In some non-limiting embodiments or aspects, each initial data point of the plurality of initial data points may have a label of a classification. In some non-limiting embodiments or aspects, geometric analysis system 102 may compute the Voronoi diagram of the initial dataset of the plurality of initial data points based on the label of the classification of each initial data point of the plurality of initial data points. Each Voronoi cell may include a region around a data point having a label, for which every point in the region is closer to the data point than any other data point.

As shown in FIG. 3A, at step 304A, process 300A includes computing one or more interior points of each Voronoi cell of the plurality of Voronoi cells. For example, geometric analysis system 102 may compute one or more interior points of each Voronoi cell of the plurality of Voronoi cells. In some non-limiting embodiments or aspects, geometric analysis system 102 may compute one or more interior points of each Voronoi cell by projecting one or more lines onto neighboring edges of Voronoi cells and determining the one or more interior points to be a midpoint on the one or more lines. In some non-limiting embodiments or aspects, the one or more interior points may be one or more test data points.

As shown in FIG. 3A, at step 306A, process 300A includes evaluating outputs of the machine learning model. For example, geometric analysis system 102 may evaluate outputs of the machine learning model that are based on an initial data point of a Voronoi cell and the one or more interior points (e.g., the one or more test data points) of the Voronoi cell. In some non-limiting embodiments or aspects, the outputs of the machine learning model may include initial outputs, which are outputs based on the initial data points, and test outputs, which are outputs based on test data points for a respective initial data point upon which a Voronoi cell is based. In some non-limiting embodiments or aspects, geometric analysis system 102 may determine whether each test output is a false positive or a true positive. For example, if geometric analysis system 102 determines that a label of a classification of a test output for a test data point of the Voronoi cell corresponds to a label of a classification of an initial output for an initial data point of the Voronoi cell, then geometric analysis system 102 may determine that the test output is a true positive. In such an example, if geometric analysis system 102 determines that a label of a classification of a test output for a test data point of the Voronoi cell does not correspond to a label of a classification of an initial output for an initial data point of the Voronoi cell, then geometric analysis system 102 may determine that the test output is a false positive.

As shown in FIG. 3A, at step 308A, process 300A includes calculating a metric associated with Voronoi cells. For example, geometric analysis system 102 may calculate the metric associated with Voronoi cells based on the outputs of the machine learning model. In some non-limiting embodiments or aspects geometric analysis system 102 may calculate the metric associated with Voronoi cells (e.g., a measure of precision associated with Voronoi cells) as a sum of test outputs of a Voronoi cell determined to be true positives divided by the sum of test outputs of a Voronoi cell determined to be true positives and a sum of test outputs of a Voronoi cell determined to be false positives.

Referring now to FIG. 3B, FIG. 3B is a flow diagram of a non-limiting embodiment or aspect of process 300B for generating a metric associated with cluster convexity with regard to a machine learning model. In some non-limiting embodiments or aspects, one or more of the steps of process 300B may be performed (e.g., completely, partially, etc.) by geometric analysis system 102 (e.g., one or more devices of geometric analysis system 102). In some non-limiting embodiments or aspects, one or more of the steps of process 300B may be performed (e.g., completely, partially, etc.) by another device or a group of devices separate from or including geometric analysis system 102 (e.g., one or more devices of geometric analysis system 102), ML model repository 104 (e.g., one or more devices of ML model repository 104), and/or user device 106.

As shown in FIG. 3B, at step 302B, process 300B includes partitioning first outputs of the machine learning model into a plurality of clusters. For example, geometric analysis system 102 may partition first outputs of the machine learning model into a plurality of clusters, where the first outputs of the machine learning model are based on each initial data point of the plurality of initial data points. In such an example, geometric analysis system 102 may provide the plurality of initial data points as inputs to the machine learning model to provide a plurality of initial outputs. Each output of the plurality of initial outputs may have a classification. For instance, each output of the plurality of initial outputs may have a label (e.g., a score for a label) associated with a prediction of a classification (e.g., a predicted classification) of the output. In the example above, geometric analysis system 102 may partition the first outputs of the machine learning model into the plurality of clusters, according to the classification of each output of the plurality of initial outputs.

As shown in FIG. 3B, at step 304B, process 300B includes calculating a median data point for each pair of data points in each cluster of the plurality of clusters. For example, geometric analysis system 102 may calculate the median data point for each pair of data points in each cluster of the plurality of clusters to provide a plurality of median data points. In some non-limiting embodiments or aspects, geometric analysis system 102 may calculate the median data point for each pair of data points as a point equal to a simple average between each pair of data points. In some non-limiting embodiments or aspects, the plurality of median data points may be a plurality of test data points.

As shown in FIG. 3B, at step 306B, process 300B includes evaluating second outputs of the machine learning model. For example, geometric analysis system 102 may evaluate second outputs of the machine learning model. In some non-limiting embodiments or aspects, geometric analysis system 102 may evaluate second outputs of the machine learning model that are based on the initial data points and the test data points. The second outputs of the machine learning model may include initial outputs, which are outputs based on the initial data points, and test outputs, which are outputs based on test data points.

As shown in FIG. 3B, at step 308B, process 300B includes calculating a metric associated with cluster convexity. For example, geometric analysis system 102 may calculate the metric associated with cluster convexity for each cluster of the plurality of clusters. In some non-limiting embodiments or aspects, the metric associated with cluster convexity may include a percentage of test outputs in a cluster that have the same classification as the initial outputs that are based on the initial data points of the cluster from which the test data point of the test output is a median point.

Referring now to FIG. 3C, FIG. 3C is a flow diagram of a non-limiting embodiment or aspect of process 300C for generating a metric associated with harmonicity with regard to a machine learning model. In some non-limiting embodiments or aspects, one or more of the steps of process 300C may be performed (e.g., completely, partially, etc.) by geometric analysis system 102 (e.g., one or more devices of geometric analysis system 102). In some non-limiting embodiments or aspects, one or more of the steps of process 300C may be performed (e.g., completely, partially, etc.) by another device or a group of devices separate from or including geometric analysis system 102 (e.g., one or more devices of geometric analysis system 102), ML model repository 104 (e.g., one or more devices of ML model repository 104), and/or user device 106.

As shown in FIG. 3C, at step 302C, process 300C includes selecting data associated with the machine learning model. For example, geometric analysis system 102 may select a subset of the plurality of initial data points of the initial dataset to provide a subset of initial data points. In some non-limiting embodiments or aspects, geometric analysis system 102 may select a subset of the plurality of initial data points based on a parameter associated with a machine learning model that is to be used to evaluate the initial dataset.

As shown in FIG. 3C, at step 304C, process 300C includes computing a space surrounding each data point of the data. For example, geometric analysis system 102 may compute a space surrounding each initial data point (e.g., a local ball of data points around each initial data point) of the subset of initial data points. In some non-limiting embodiments or aspects, for each initial data point of the subset of initial data points, geometric analysis system 102 may compute a plurality of local points that are equally spaced from the initial data point. In some non-limiting embodiments or aspects, the plurality of local data points may be a plurality of test data points.

As shown in FIG. 3C, at step 306C, process 300C includes evaluating outputs of the machine learning model. For example, geometric analysis system 102 may evaluate outputs of the machine learning model. In some non-limiting embodiments or aspects, geometric analysis system 102 may evaluate outputs of the machine learning model that are based on the initial data points and the test data points. The outputs of the machine learning model may include initial outputs, which are outputs based on the initial data points, and test outputs, which are outputs based on the test data points.

As shown in FIG. 3C, at step 308C, process 300C includes calculating a metric associated with harmonicity. For example, geometric analysis system 102 may calculate the metric associated with harmonicity based on the subset of initial data points. In some non-limiting embodiments or aspects, for each initial data point of the subset of initial data points, an average number of test outputs of data points that are different from an initial output are divided by a total number of test outputs to provide a local average. The metric associated with harmonicity is an average of all local averages for the initial data points of the subset of initial data points.

Referring now to FIG. 3D, FIG. 3D is a flow diagram of a non-limiting embodiment or aspect of process 300D for generating a metric associated with harmonicity with regard to a machine learning model. In some non-limiting embodiments or aspects, one or more of the steps of process 300D may be performed (e.g., completely, partially, etc.) by geometric analysis system 102 (e.g., one or more devices of geometric analysis system 102). In some non-limiting embodiments or aspects, one or more of the steps of process 300D may be performed (e.g., completely, partially, etc.) by another device or a group of devices separate from or including geometric analysis system 102 (e.g., one or more devices of geometric analysis system 102), ML model repository 104 (e.g., one or more devices of ML model repository 104), and/or user device 106.

As shown in FIG. 3D, at step 302D, process 300D includes selecting data associated with the machine learning model. For example, geometric analysis system 102 may select a subset of the plurality of initial data points of the initial dataset to provide a subset of initial data points. In some non-limiting embodiments or aspects, geometric analysis system 102 may select a subset of the plurality of initial data points based on a parameter associated with a machine learning model that is to be used to evaluate the initial dataset.

As shown in FIG. 3D, at step 304D, process 300D includes computing a grid surrounding each data point of the data. For example, geometric analysis system 102 may compute a grid surrounding each initial data point (e.g., a local grid of data points around each initial data point) of the subset of initial data points. In some non-limiting embodiments or aspects, for each initial data point of the subset of initial data points, geometric analysis system 102 may compute a plurality of local grid data points that are located within a grid from the initial data point. In some non-limiting embodiments or aspects, the plurality of local grid data points may be a plurality of test data points.

As shown in FIG. 3D, at step 306D, process 300D includes evaluating outputs of the machine learning model. For example, geometric analysis system 102 may evaluate outputs of the machine learning model. In some non-limiting embodiments or aspects, geometric analysis system 102 may evaluate outputs of the machine learning model that are based on the initial data points and the test data points. The outputs of the machine learning model may include initial outputs, which are outputs based on the initial data points, and test outputs, which are outputs based on the test data points. In some non-limiting embodiments or aspects, geometric analysis system 102 may measure a number of outputs which are above a threshold for an output. For example, geometric analysis system 102 may measure a number of outputs that have a particular classification (e.g., a classification score associated with a particular classification, such as a fraud classification).

As shown in FIG. 3D, at step 308D, process 300D includes reducing a mesh size of each grid. For example, geometric analysis system 102 may reduce a mesh size of each grid surrounding each initial data point of the subset of initial data points. In some non-limiting embodiments or aspects, geometric analysis system 102 may reduce a mesh size of each grid based on the number of outputs which are above a threshold for an output of the machine learning model. For example, geometric analysis system 102 may reduce a mesh size of each grid to reduce the number of outputs which are above a threshold in each grid.

As shown in FIG. 3D, at step 310D, process 300D includes determining whether a mesh size of a grid satisfies a threshold value. For example, geometric analysis system 102 may determine whether a mesh size of each grid surrounding each initial data point of the subset of initial data points satisfies a threshold value (e.g., a threshold value of a mesh size of a grid and/or a threshold value of a mesh size of a grid that is based on a number of outputs which are above a threshold for an output of the machine learning model). In one example, geometric analysis system 102 may compare the mesh size of each grid to the threshold value and, if the mesh size of each grid does not satisfy the threshold value (e.g., “NO” at step 310D), then geometric analysis system 102 may repeat steps 306D and 308D. In such an example, geometric analysis system 102 may compare the mesh size of each grid to the threshold value and, if the mesh size of each grid satisfies the threshold value (e.g., “YES” at step 310D), then geometric analysis system 102 may compute a fractal dimension for each grid.

As shown in FIG. 3D, at step 312D, process 300D includes computing a fractal dimension for each grid. For example, geometric analysis system 102 may compute a fractal dimension for each grid surrounding each initial data point of the subset of initial data points. In some non-limiting embodiments or aspects, geometric analysis system 102 may compute the fractal dimension for each grid by performing a box counting procedure (e.g., a procedure based on a Minkowski-Bouligand dimension) on each respective grid.

As shown in FIG. 3D, at step 314D, process 300D includes calculating a metric associated with fractal dimensions. For example, geometric analysis system 102 may calculate a metric associated with fractal dimensions by averaging the fractal dimensions for each grid surrounding each initial data point of the subset of initial data points.

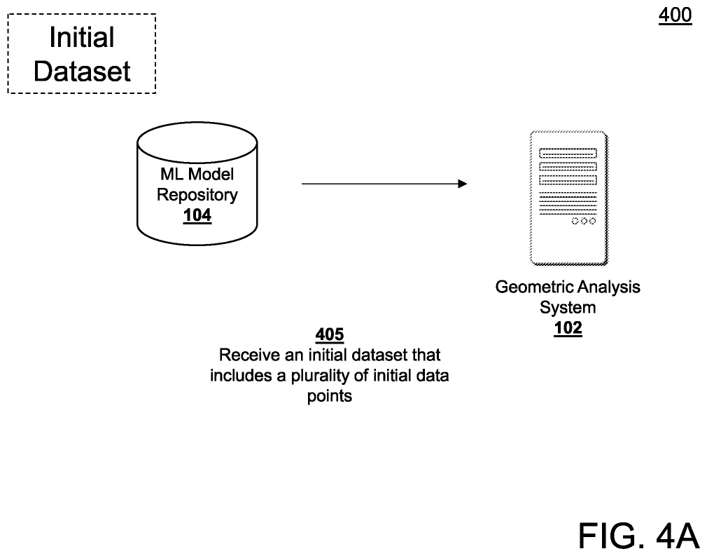

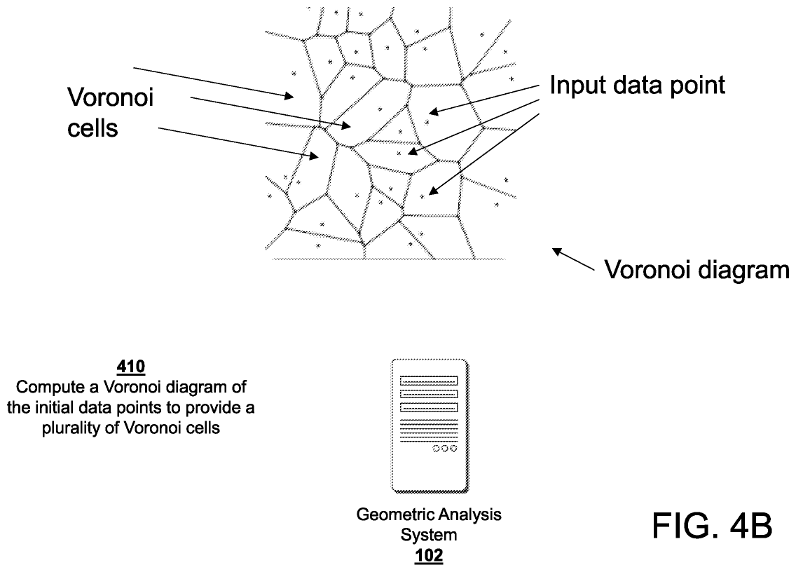

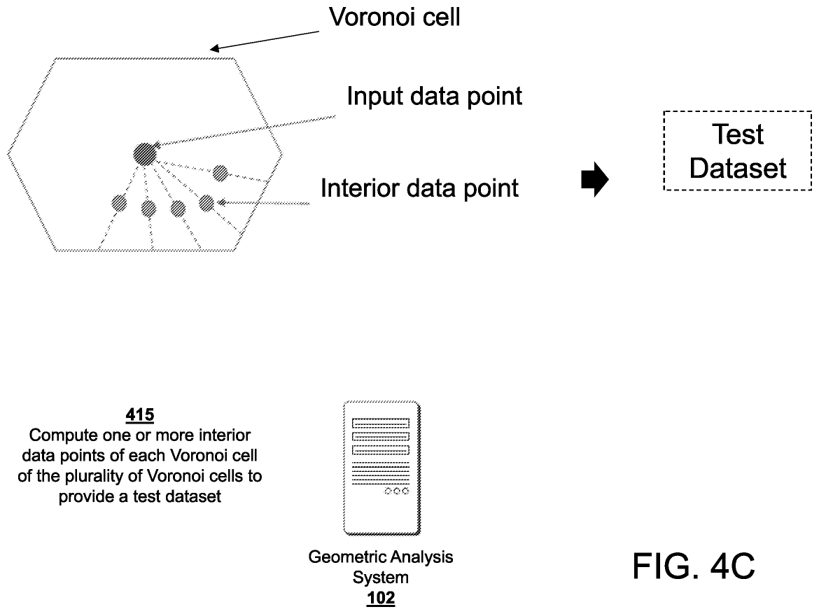

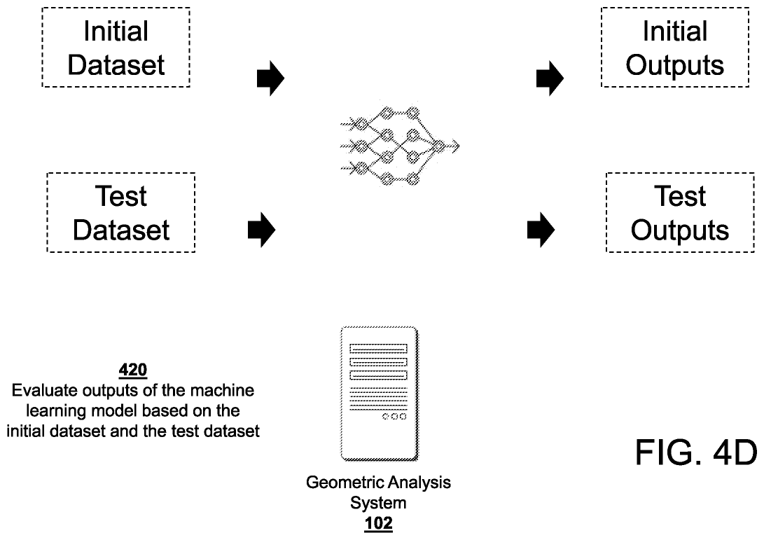

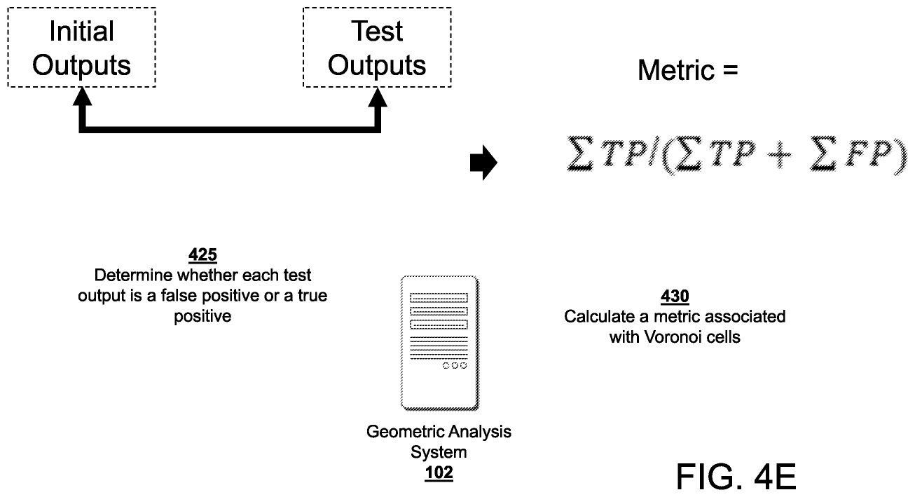

Referring now to FIGS. 4A-4E, shown are schematic diagrams of implementation 400 of a process (e.g., process 300A) for generating a metric associated with Voronoi cells with regard to a machine learning model. In some non-limiting embodiments or aspects, one or more of the steps of the process may be performed (e.g., completely, partially, etc.) by geometric analysis system 102 (e.g., one or more devices of geometric analysis system 102). In some non-limiting embodiments or aspects, one or more of the steps of the process may be performed (e.g., completely, partially, etc.) by another device or a group of devices separate from or including geometric analysis system 102 (e.g., one or more devices of geometric analysis system 102), ML model repository 104, and/or user device 106.

As shown by reference number 405 in FIG. 4A, geometric analysis system 102 may receive an initial dataset that includes a plurality of initial data points from ML model repository 104. In some non-limiting embodiments or aspects, geometric analysis system 102 may receive data associated with a machine learning model that includes an ML model file for the machine learning model. The ML model file may be based on a production machine learning model and may be used by geometric analysis system 102 to execute operations (e.g., generate outputs based on inputs) using the machine learning model. In some non-limiting embodiments or aspects, geometric analysis system 102 may retrieve the initial dataset from ML model repository 104 based on receiving a request from user device 106. As shown by reference number 410 in FIG. 4B, geometric analysis system 102 may compute a Voronoi diagram of the initial data points to provide a plurality of Voronoi cells. In some non-limiting embodiments or aspects, the Voronoi diagram may be based on labels (e.g., predetermined labels) of classifications of the initial data points.

As shown by reference number 415 in FIG. 4C, geometric analysis system 102 may compute one or more interior data points of each Voronoi cell of the plurality of Voronoi cells to provide a test dataset. In some non-limiting embodiments or aspects, geometric analysis system 102 may compute a plurality of interior data points of each Voronoi cell by projecting a plurality of lines onto neighboring edges of Voronoi cells and determining the plurality of interior data points to be midpoint on the plurality of lines. In some non-limiting embodiments or aspects, the plurality of interior data points may be a plurality of test data points of the test dataset.

As shown by reference number 420 in FIG. 4D, geometric analysis system 102 may evaluate outputs of the machine learning model based on the initial dataset and the test dataset. In some non-limiting embodiments or aspects, the outputs of the machine learning model may include initial outputs, which are outputs based on the initial data points, and test outputs, which are outputs based on the test data points for a respective initial data point upon which a Voronoi cell is based.

As shown by reference number 425 in FIG. 4E, geometric analysis system 102 may determine whether each test output is a false positive or a true positive. For example, if geometric analysis system 102 determines that a label of a classification of a test output for a test data point of the Voronoi cell corresponds to a label of a classification of an initial output for an initial data point of the Voronoi cell, then geometric analysis system 102 may determine that the test output is a true positive. In such an example, if geometric analysis system 102 determines that a label of a classification of a test output for a test data point of the Voronoi cell does not correspond to a label of a classification of an initial output for an initial data point of the Voronoi cell, then geometric analysis system 102 may determine that the test output is a false positive. As shown by reference number 430 in FIG. 4E, geometric analysis system 102 may calculate a metric associated with Voronoi cells. For example, geometric analysis system 102 may calculate the metric associated with Voronoi cells based on the outputs of the machine learning model. In some non-limiting embodiments or aspects, geometric analysis system 102 may calculate the metric associated with Voronoi cells (e.g., a measure of precision associated with Voronoi cells) as a sum of test outputs of a Voronoi cell determined to be true positives divided by the sum of test outputs of a Voronoi cell determined to be true positives and a sum of test outputs of a Voronoi cell determined to be false positives.

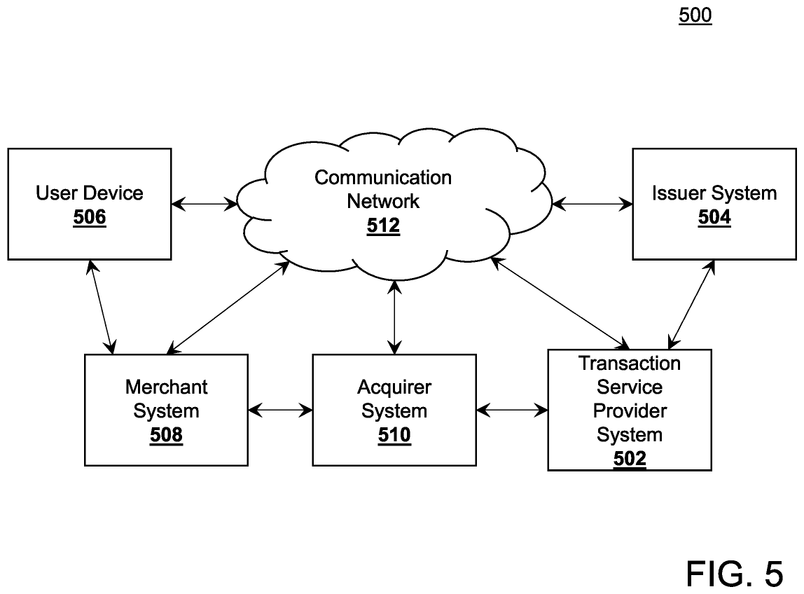

Referring now to FIG. 5, FIG. 5 is a diagram of a non-limiting embodiment or aspect of environment 500 in which systems, products, and/or methods, as described herein, may be implemented. As shown in FIG. 5, environment 500 may include transaction service provider system 502, issuer system 504, user device 506, merchant system 508, acquirer system 510, and communication network 512. In some non-limiting embodiments or aspects, each of geometric analysis system 102, ML model repository 104, and/or user device 106 of FIG. 1 may be implemented by (e.g., part of) transaction service provider system 502. In some non-limiting embodiments or aspects, at least one of geometric analysis system 102, ML model repository 104, and/or user device 106 of FIG. 1 may be implemented by (e.g., part of) another system, another device, another group of systems, or another group of devices, separate from or including transaction service provider system 502, such as issuer system 504, user device 506, merchant system 508, acquirer system 510, and/or the like.

Transaction service provider system 502 may include one or more devices capable of receiving information from and/or communicating information to issuer system 504, user device 506, merchant system 508, and/or acquirer system 510 via communication network 512. For example, transaction service provider system 502 may include a computing device, such as a server (e.g., a transaction processing server), a group of servers, and/or other like devices. In some non-limiting embodiments or aspects, transaction service provider system 502 may be associated with a transaction service provider as described herein. In some non-limiting embodiments or aspects, transaction service provider system 502 may be in communication with a data storage device, which may be local or remote to transaction service provider system 502. In some non-limiting embodiments or aspects, transaction service provider system 502 may be capable of receiving information from, storing information in, communicating information to, or searching information stored in the data storage device.

Issuer system 504 may include one or more devices capable of receiving information and/or communicating information to transaction service provider system 502, user device 506, merchant system 508, and/or acquirer system 510 via communication network 512. For example, issuer system 504 may include a computing device, such as a server, a group of servers, and/or other like devices. In some non-limiting embodiments or aspects, issuer system 504 may be associated with an issuer institution as described herein. For example, issuer system 504 may be associated with an issuer institution that issued a credit account, debit account, credit card, debit card, and/or the like to a user associated with user device 506.

User device 506 may include one or more devices capable of receiving information from and/or communicating information to transaction service provider system 502, issuer system 504, merchant system 508, and/or acquirer system 510 via communication network 512. Additionally or alternatively, each user device 506 may include a device capable of receiving information from and/or communicating information to other user devices 506 via communication network 512, another network (e.g., an ad hoc network, a local network, a private network, a virtual private network, and/or the like), and/or any other suitable communication technique. For example, user device 506 may include a client device and/or the like. In some non-limiting embodiments or aspects, user device 506 may or may not be capable of receiving information (e.g., from merchant system 508 or from another user device 506) via a short-range wireless communication connection (e.g., a near field communication (NFC) connection, a radio frequency identification (RFID) communication connection, a Bluetooth® communication connection, a Zigbee® communication connection, and/or the like), and/or communicating information (e.g., to merchant system 508) via a short-range wireless communication connection.

Merchant system 508 may include one or more devices capable of receiving information from and/or communicating information to transaction service provider system 502, issuer system 504, user device 506, and/or acquirer system 510 via communication network 512. Merchant system 508 may also include a device capable of receiving information from user device 506 via communication network 512, a communication connection (e.g., an NFC connection, an RFID communication connection, a Bluetooth® communication connection, a Zigbee® communication connection, and/or the like) with user device 506, and/or the like, and/or communicating information to user device 506 via communication network 512, the communication connection, and/or the like. In some non-limiting embodiments or aspects, merchant system 508 may include a computing device, such as a server, a group of servers, a client device, a group of client devices, and/or other like devices. In some non-limiting embodiments or aspects, merchant system 508 may be associated with a merchant as described herein. In some non-limiting embodiments or aspects, merchant system 508 may include one or more client devices. For example, merchant system 508 may include a client device that allows a merchant to communicate information to transaction service provider system 502. In some non-limiting embodiments or aspects, merchant system 508 may include one or more devices, such as computers, computer systems, and/or peripheral devices capable of being used by a merchant to conduct a transaction with a user. For example, merchant system 508 may include a POS device and/or a POS system.

Acquirer system 510 may include one or more devices capable of receiving information from and/or communicating information to transaction service provider system 502, issuer system 504, user device 506, and/or merchant system 508 via communication network 512. For example, acquirer system 510 may include a computing device, a server, a group of servers, and/or the like. In some non-limiting embodiments or aspects, acquirer system 510 may be associated with an acquirer as described herein.

Communication network 512 may include one or more wired and/or wireless networks. For example, communication network 512 may include a cellular network (e.g., a long-term evolution (LTE) network, a third generation (3G) network, a fourth generation (4G) network, a fifth generation (5G) network, a code division multiple access (CDMA) network, and/or the like), a public land mobile network (PLMN), a local area network (LAN), a wide area network (WAN), a metropolitan area network (MAN), a telephone network (e.g., the public switched telephone network (PSTN)), a private network (e.g., a private network associated with a transaction service provider), an ad hoc network, an intranet, the Internet, a fiber optic-based network, a cloud computing network, and/or the like, and/or a combination of these or other types of networks.

The number and arrangement of systems, devices, and/or networks shown in FIG. 5 are provided as an example. There may be additional systems, devices, and/or networks; fewer systems, devices, and/or networks; different systems, devices, and/or networks; and/or differently arranged systems, devices, and/or networks than those shown in FIG. 5. Furthermore, two or more systems or devices shown in FIG. 5 may be implemented within a single system or device, or a single system or device shown in FIG. 5 may be implemented as multiple, distributed systems or devices. Additionally or alternatively, a set of systems (e.g., one or more systems) or a set of devices (e.g., one or more devices) of environment 500 may perform one or more functions described as being performed by another set of systems or another set of devices of environment 500.

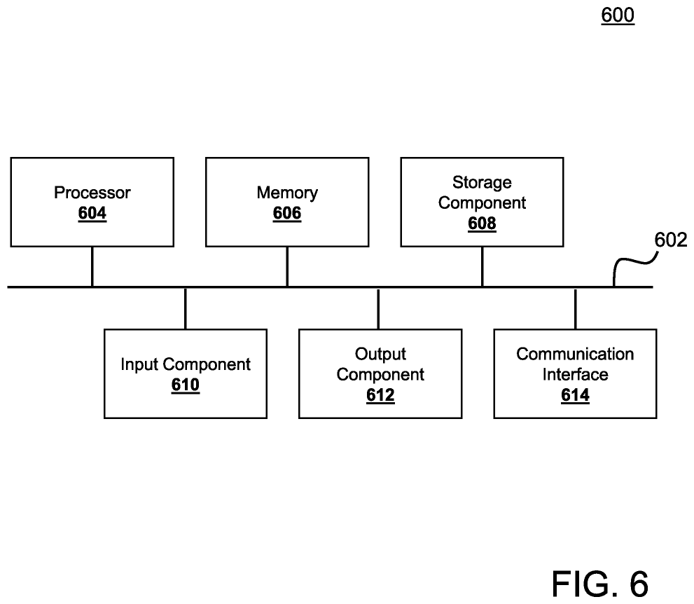

Referring now to FIG. 6, shown is a diagram of example components of device 600, according to some non-limiting embodiments or aspects. Device 600 may correspond to at least one of geometric analysis system 102, ML Model repository 104, and/or user device 106 in FIG. 1 and/or at least one of transaction service provider system 502, issuer system 504, user device 506, merchant system 508, and/or acquirer system 510 in FIG. 5, as an example. In some non-limiting embodiments or aspects, such systems or devices in FIG. 1 or FIG. 5 may include at least one device 600 and/or at least one component of device 600. The number and arrangement of components shown in FIG. 6 are provided as an example. In some non-limiting embodiments or aspects, device 600 may include additional components, fewer components, different components, or differently arranged components than those shown in FIG. 6. Additionally or alternatively, a set of components (e.g., one or more components) of device 600 may perform one or more functions described as being performed by another set of components of device 600.

As shown in FIG. 6, device 600 may include bus 602, processor 604, memory 606, storage component 608, input component 610, output component 612, and communication interface 614. Bus 602 may include a component that permits communication among the components of device 600. In some non-limiting embodiments or aspects, processor 604 may be implemented in hardware, firmware, or a combination of hardware and software. For example, processor 604 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 606 may include random access memory (RAM), read only memory (ROM), and/or another type of dynamic or static storage device (e.g., flash memory, magnetic memory, optical memory, etc.) that stores information and/or instructions for use by processor 604.

With continued reference to FIG. 6, storage component 608 may store information and/or software related to the operation and use of device 600. For example, storage component 608 may include a hard disk (e.g., a magnetic disk, an optical disk, a magneto-optic disk, a solid state disk, etc.) and/or another type of computer-readable medium. Input component 610 may include a component that permits device 600 to receive information, such as via user input (e.g., a touch screen display, a keyboard, a keypad, a mouse, a button, a switch, a microphone, etc.). Additionally or alternatively, input component 610 may include a sensor for sensing information (e.g., a global positioning system (GPS) component, an accelerometer, a gyroscope, an actuator, etc.). Output component 612 may include a component that provides output information from device 600 (e.g., a display, a speaker, one or more light-emitting diodes (LEDs), etc.). Communication interface 614 may include a transceiver-like component (e.g., a transceiver, a separate receiver and transmitter, etc.) that enables device 600 to communicate with other devices, such as via a wired connection, a wireless connection, or a combination of wired and wireless connections. Communication interface 614 may permit device 600 to receive information from another device and/or provide information to another device. For example, communication interface 614 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 600 may perform one or more processes described herein. Device 600 may perform these processes based on processor 604 executing software instructions stored by a computer-readable medium, such as memory 606 and/or storage component 608. A computer-readable medium may include any non-transitory memory device. A memory device includes memory space located inside of a single physical storage device or memory space spread across multiple physical storage devices. Software instructions may be read into memory 606 and/or storage component 608 from another computer-readable medium or from another device via communication interface 614. When executed, software instructions stored in memory 606 and/or storage component 608 may cause processor 604 to perform one or more processes described herein. Additionally or alternatively, hardwired circuitry may be used in place of or in combination with software instructions to perform one or more processes described herein. Thus, embodiments described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

1. A computer-implemented method, comprising:
receiving, with at least one processor, data associated with a machine learning model;
determining, with at least one processor, classifications of the data associated with the machine learning model based on outputs of the machine learning model;
generating, with at least one processor, one or more metrics associated with a geometry of a decision boundary of the machine learning model; and
determining, with at least one processor, whether to perform an action on the machine learning model based on the one or more metrics associated with the geometry of the decision boundary.

2. The computer-implemented method of claim 1, further comprising:
comparing the one or more metrics associated with the geometry of the decision boundary to a threshold value; and
determining whether the one or more metrics associated with the geometry of the decision boundary satisfy the threshold value;
wherein determining whether to perform the action on the machine learning model comprises:
determining whether to perform the action on the machine learning model based on determining whether the one or more metrics associated with the geometry of the decision boundary satisfy the threshold value.

3. The computer-implemented method of claim 1, wherein the one or more metrics comprise at least one of the following:
a metric associated with Voronoi cells;
a metric associated with a cluster convexity; or
any combination thereof.

4. The computer-implemented method of claim 1, wherein generating the one or more metrics associated with the geometry of the decision boundary of the machine learning model comprises:
generating the one or more metrics associated with the geometry of the decision boundary of the machine learning model at a predetermined time interval.

5. The computer-implemented method of claim 1, wherein the one or more metrics associated with the geometry of the decision boundary of the machine learning model is a metric associated with Voronoi cells, and wherein generating the one or more metrics associated with the geometry of the decision boundary comprises:
receiving input data associated with the machine learning model;
computing a Voronoi diagram of the input data to provide a plurality of cells;
computing one or more interior points of each cell of the plurality of cells;
evaluating an output of the machine learning model based on the one or more interior points of each cell; and
calculating the metric associated with the Voronoi cells based on the output of the machine learning model for the one or more interior points of each cell.

6. The computer-implemented method of claim 1, wherein the one or more metrics associated with the geometry of the decision boundary of the machine learning model is a metric associated with a cluster convexity, and wherein generating the one or more metrics associated with the geometry of the decision boundary comprises:
receiving input data associated with the machine learning model, wherein the input data comprises a plurality of data points;
evaluating a first output of the machine learning model based on the plurality of data points;
partitioning the first output of the machine learning model into a plurality of clusters;
calculating a median data point for each pair of data points in each cluster of the plurality of clusters to provide a plurality of median data points;
evaluating a second output of the machine learning model based on the plurality of median data points; and
calculating the metric associated with the cluster convexity based on the first output and the second output of the machine learning model.

7. The computer-implemented method of claim 1, further comprising:
performing the action on the machine learning model based on determining that the one or more metrics associated with the geometry of the decision boundary satisfy a threshold value.

8. A system, comprising:
at least one processor configured to:
receive data associated with a machine learning model;
determine classifications of the data associated with the machine learning model based on outputs of the machine learning model;
generate one or more metrics associated with a geometry of a decision boundary of the machine learning model; and
determine whether to perform an action on the machine learning model based on the one or more metrics associated with the geometry of the decision boundary of the machine learning model.

9. The system of claim 8, wherein the at least one processor is further configured to:
compare the one or more metrics associated with the geometry of the decision boundary to a threshold value; and
determine whether the one or more metrics associated with the geometry of the decision boundary satisfy the threshold value; and
wherein, when determining whether to perform the action on the machine learning model, the at least one processor is configured to:
determine whether to perform the action on the machine learning model based on determining whether the one or more metrics associated with the geometry of the decision boundary satisfy the threshold value.

10. The system of claim 8, wherein the one or more metrics comprise at least one of the following:
a metric associated with Voronoi cells;
a metric associated with a cluster convexity; or
any combination thereof.

11. The system of claim 8, wherein, when generating the one or more metrics associated with the geometry of the decision boundary of the machine learning model, the at least one processor is configured to:
generate the one or more metrics associated with the geometry of the decision boundary of the machine learning model at a predetermined time interval.

12. The system of claim 8, wherein the one or more metrics associated with the geometry of the decision boundary of the machine learning model is a metric associated with Voronoi cells, and wherein, when generating the one or more metrics associated with the geometry of the decision boundary, the at least one processor is configured to:
receive input data associated with the machine learning model;
compute a Voronoi diagram of the input data to provide a plurality of cells;
compute one or more interior points of each cell of the plurality of cells;
evaluate an output of the machine learning model based on the one or more interior points of each cell; and
calculate the metric associated with the Voronoi cells based on the output of the machine learning model for the one or more interior points of each cell.

13. The system of claim 8, wherein the one or more metrics associated with the geometry of the decision boundary of the machine learning model is a metric associated with a cluster convexity, and wherein, when generating the one or more metrics associated with the geometry of the decision boundary, the at least one processor is configured to:
receive input data associated with the machine learning model, wherein the input data comprises a plurality of data points;
evaluate a first output of the machine learning model based on the plurality of data points;
partition the first output of the machine learning model into a plurality of clusters;
calculate a median data point for each pair of data points in each cluster of the plurality of clusters to provide a plurality of median data points;
evaluate a second output of the machine learning model based on the plurality of median data points; and
calculate the metric associated with the cluster convexity based on the first output and the second output of the machine learning model.

14. The system of claim 1, wherein the at least one processor is further configured to:
perform the action on the machine learning model based on determining that the one or more metrics associated with the geometry of the decision boundary satisfy a threshold value.

15. A computer program product comprising at least one non-transitory computer-readable medium including program instructions that, when executed by at least one processor, cause the at least one processor to:
receive data associated with a machine learning model;
determine classifications of the data associated with the machine learning model based on outputs of the machine learning model;
generate one or more metrics associated with a geometry of a decision boundary of the machine learning model; and
determine whether to perform an action on the machine learning model based on the one or more metrics associated with the geometry of the decision boundary.

16. The computer program product of claim 15, wherein the instructions further cause the at least one processor to:
compare the one or more metrics associated with the geometry of the decision boundary to a threshold value; and
determine whether the one or more metrics associated with the geometry of the decision boundary satisfy the threshold value; and
wherein, the instructions that cause the at least one processor to determine whether to perform the action on the machine learning model, cause the at least one processor to:
determine whether to perform the action on the machine learning model based on determining whether the one or more metrics associated with the geometry of the decision boundary satisfy the threshold value.

17. The computer program product of claim 15, wherein the one or more metrics comprise at least one of the following:
a metric associated with Voronoi cells;
a metric associated with a cluster convexity; or
any combination thereof.

18. The computer program product of claim 15, wherein, the instructions that cause the at least one processor to generate the one or more metrics associated with the geometry of the decision boundary of the machine learning model, cause the at least one processor to:
generate the one or more metrics associated with the geometry of the decision boundary of the machine learning model at a predetermined time interval.

19. The computer program product of claim 15, wherein the one or more metrics associated with the geometry of the decision boundary of the machine learning model is a metric associated with Voronoi cells, and wherein, the instructions that cause the at least one processor to generate the one or more metrics associated with the geometry of the decision boundary, cause the at least one processor to:
receive input data associated with the machine learning model;
compute a Voronoi diagram of the input data to provide a plurality of cells;
compute one or more interior points of each cell of the plurality of cells;
evaluate an output of the machine learning model based on the one or more interior points of each cell; and
calculate the metric associated with the Voronoi cells based on the output of the machine learning model for the one or more interior points of each cell.

20. The computer program product of claim 15, wherein the one or more metrics associated with the geometry of the decision boundary of the machine learning model is a metric associated with a cluster convexity, and wherein, the instructions that cause the at least one processor to generate the one or more metrics associated with the geometry of the decision boundary, cause the at least one processor to:
receive input data associated with the machine learning model, wherein the input data comprises a plurality of data points;
evaluate a first output of the machine learning model based on the plurality of data points;
partition the first output of the machine learning model into a plurality of clusters;
calculate a median data point for each pair of data points in each cluster of the plurality of clusters to provide a plurality of median data points;
evaluate a second output of the machine learning model based on the plurality of median data points; and
calculate the metric associated with the cluster convexity based on the first output and the second output of the machine learning model.

21. (canceled)
